(19) United States
(12) Patent Application Publication
(10) Pub. No.: US 2004/0068435 A1
(43) Pub. Date: Apr. 8, 2004

(54) Method of automated Ad campaign management

(76) Inventor: Scot Braunzell, New York, NY (US)

Correspondence Address: F. RHETT BROCKINGTON, 4809-302 ALEXANDER VALLEY DRIVE, CHARLOTTE, NC, 28270, US

(21) Appl. No.: 10/192,877

(22) Filed: Jul. 9, 2002

Related U.S. Application Data
(60) Provisional application No. 60/303,438, filed on Jul. 9, 2001.

(51) Int. Cl. G06F 17/60

(52) U.S. Cl. 705/14

(57) ABSTRACT

The invention is a method for automated management of Internet advertising campaigns. The method facilitates and automates the services and exchange of information between the publisher and the advertiser, who is the client. The method implores an Ad Manager having a customized proactive reporting (CPR), which enables the client to conduct queries online as to the current status of his online Ad campaign. CPR facilitates the need that a client has better reporting on Ad campaigns in the online advertising arena. The application is database driven. Databases, such as DB2®, Oracle, ® and PHP®, with sophisticated spreadsheet analysis, like Excel and Lotus, can be used. CPR aggregates content from several different Ad server platforms, and then produces a set of campaign statistics that is then returned to the client in an easy to read web based format. The data can be cross-referenced to any data that the client deems pertinent. The Ad Manager of the method employs a queue management system (QMS), which is an open channel between the publisher/Ad agency and its client advertisers, that automates the management of the client's Ad campaign work-flow. There is an alert system, which monitors the response times to a client's request, and the alert system, which is weighted according to the level of urgency as determined by the client, can dynamically sort client requests

### CROSS-REFERENCES TO RELATED APPLICATIONS

This application claims benefit under 35 U.S.C. section 119 of provisional application 60/303,438 filed Jul. 9, 2001. The disclosure of this application is incorporated by reference herein in its entirety.

### FIELD OF THE INVENTION

This invention relates generally to methods to managing Internet Advertisement Campaigns, and more particularly to a method that automates managing and launching Internet Advertisement Campaigns, wherein the advertisements can be viewer targeted advertisements.

### BACKGROUND OF THE INVENTION

Internet advertisement campaigns are waged at various levels of sophistication. On a relatively low level of sophistication having little customer analysis, the advertisements are generated by a data warehouse, which superimposes the advertisement on the web page of the host computer. The advertisement is generated by the data warehouse's computer and transmitted to the viewer's computer when the web page is browsed. At a significantly higher level of sophistication, the data warehouse computer is configured so that the advertisement that is transmitted is tailored to a targeted viewer (e.g. the potential customer). The process of tailoring an advertisement requires greater knowledge of the viewer. Demographic criteria that are used are location, age, sex, previously identified areas of interest, education, time-of-day, how many times the advertisement has been show to the viewer, etceteras. Much of the analysis of Ad campaigns is evaluating tracking data, where tracking data are who, what, where, when and how historical records of the viewers browsing habits. Not surprisingly, studies have confirmed that past preferences are strongly predictive of future behavior. The prior art, and in particular Merriman et al of Double Click, Inc in their U.S. Pat. No. 5,948,061 disclose a method for implementing a tailored advertisement. In essence, the database filters through criteria before selecting which Ad to place on the host's web page. The process of placing an advertisement is highly automated, and therein cost effective.

Behind the scenes online Publishers and Ad agencies are still using business methods that are, to borrow from a well-worn phrase, “The old fashion way”. The publisher sales force submits an order, usually by email or fax, and then the in-house manager, after obtaining the proper approvals, enters the order. Typical information includes the advertiser, the campaign name, advertiser ID, cost (CPM), the start and end dates, and targeting criteria. Billing is manually pulled from the Ad server. Publishers and Ad agencies are increasing under pressure to improve their productivity. As businesses aim to streamline staff through cost-saving initiatives, automating work-flows through applications that improve tracking, reporting, and decision making processes are critical to efficient operations. In the online advertising industry in particular, clients require meticulous tracking of all campaigns and orders processed across a multitude of classification fields in order to optimize campaign management and ensure accurate and timely billing and reporting functions. Traditionally these processes have been done manually through cumbersome order forms, that are not logged electronically, and human error is significant (industry average error rates exceed 5%). Publishers and Ad agencies, and their clients, the Advertisers, are also increasingly looking to automate billing functions and employee time management, which requires integration with order processing and timesheet logs. In short, what is needed is a commensurate level of automation applied to the methods of managing an Ad campaign, as the level of automation for displaying the Ads.

### OBJECTS OF THE INVENTION

A first object of the invention is a report that can be accessed by the client, where the report is interactive; wherein the client can proactively specify the data and the presentation format that is most relevant to their needs.

A second object of the invention is that reporting be actively supported by advertising consultants, with both marketing and technical expertise, to optimize the effectiveness of the advertising campaigns.

A third object of the invention is that the report has the capability to drill down to the details, which support a graphical presentation in the report. The report is to include click-through rate, number and rate of page or tile impressions, frequency of viewing, time-of-day, geographical region, and browser/operating systems.

A fourth object of the invention is that the advertising campaign report should have cross-the-board compatibility with the various Internet browsers, like Netscape® and Internet Explorer®, and be downloadable in to a universally accepted platform.

A fifth object of the invention is that the data be available be provided in universally utilized database formats, such as DB2®, Oracle, ® and PHP®, where sophisticated spreadsheet analysis, like Excel and Lotus, can be used.

A sixth object of the invention is that the Advertisers have automated electronic order entry, tagged with unique case ID, request type, completion date, and specific tasks completed.

A seventh object of the invention is that the publisher and the client are in up-to-the minute electronic communication with the Ad server database for analysis of the campaigns, and in the case of tailored advertisements, confirmation that the designated filtering criteria are operative and effective.

### SUMMARY OF THE INVENTION

The invention is a method for automated management of Internet advertising campaigns. The method facilitates and automates the services and exchange of information between the publisher and the advertiser, who is the client. The method implores an Ad Manager having a customized proactive reporting (CPR), which enables the client to conduct queries online as to the current status of his online Ad campaign. CPR facilitates the need that a client has better reporting on Ad campaigns in the online advertising arena. The application is database driven. Databases, such as DB2®, Oracle, ® and PHP®, with sophisticated spreadsheet analysis, like Excel and Lotus, can be used. CPR aggregates content from several different Ad server platforms, and then produces a set of campaign statistics that is then returned to the client in an easy to read web based format. The data can be cross-referenced to any data that the client deems pertinent. Examples include cost of Ads versus units of product sold, demographics of the purchaser, units versus hits, etc. The client (or his designate) selects the platform. HTML, XML or Excel® are commonly preferred platforms. CPR is built as an ASP (application service provider) model, but can be deployed or run as a local application at the publisher (or his designated manager—i.e. Ad agency). At the core of the application is a VB (Visual Basic) parser that does data collection and distribution to a SQL Database. The front end of the application of the invention is completely web enabled and cross browser-platform compatible. The data is drawn from a combination of sources including directly from the Ad server database, the web user interface or from the server logs (or tables) from the web server, and presented graphically or in a character format or a blend thereof. As previously stated, the CPR integrates with the Ad server—publisher interface (or when available directly with the Ad server database), and parses the Ad server data into a customized client-side interface. The CPR provides customized client-side field inputs and dynamically converts client inputs into standardized Ad serving outputs in excel html csv or xml data types. The output data is selected in part to maximize analysis with respect the client's evaluation as to the management of his online Ad campaign. For the publisher, the output data includes revenue forecasts broken down into subcategories such as revenues by campaign and site (web page) level. The output data also includes trends by advertiser and site level, campaign ranking by click through rate, impression rate, on-time delivery and rate of delivery. Marketing output data information about the viewer/target customer is generated, including previously identified criteria such as page or tile that was browsed, geographical region, time of day and day of week, frequency of viewing and browser/operating system. The method enables the publisher to analyze his web page inventory. The method identifies pockets of unsold inventory, computes the cost of unsold inventory, and forecasts the availability of inventory. The inventory can be broken down by network, site, area, and web page name. Through inventory analysis the publisher can merge targeting criteria with available inventory to generate pre-package media selling opportunities.

The Ad Manager of the method employs a queue management system (QMS), which is an open channel between the publisher and his clients, that automates the management of the clients Ad campaign work-flow. Typically, a customer relationship management application (CRM) is used to augment structured query language (SQL) queries. Additionally, an application programming interface (API) is used to query the Ad server. When a client makes a request the client's requests are logged and tagged with a unique case ID, a request type, a completion date, and a specific task(s) to be completed. There is an alert system, which monitors the response times to a client's request, and the alert system, which is weighted according to the level of urgency as determined by the client, can dynamically sort client requests. The dynamic sorting and reallocation of requests is prioritized via the client employees, that stage queues, which are dependent on resource availability. The client and the publisher can track an Ad campaign by turnaround times, billing terms, units, and rates on an individual basis, or on an aggregate basis. The client and the publisher can also track aggregates, which provide an overview of billing, work-log, and performance summaries on a client-by-client basis, to easily identify resource utilization, productivity, and ROI. The aggregates are particularly useful to the publisher in identifying how well their various clients' Ad campaigns are performing.

The method further comprising providing a web page trafficker for tracking who, what, where, when and how the viewer browsed the client's web page. This information can be downloaded and cross referenced to the collected data from the Ad server, and therein enabling analysis of which Ad campaign brought the viewer to the client's web page.

The method utilizes an open platform, enabling e-business® with vendors and suppliers. The method can be supplemented with an Ad consultant, which is an artificial intelligence (AI) application having expert knowledge in Ad campaigns. The Ad consultant can also be a person(s), or a person(s), or a person(s) utilizing an AI application expert.

It is anticipated that the method of automated Ad campaign management employs an application that is holistic, robust and client friendly. The application can use customer relationship management tools, such as CRM® by Salesforce.com to facilitate API queries.

### BRIEF DESCRIPTION OF THE DRAWINGS

FIG. 1 is a flow diagram illustrating the overall schema of the invention and the operational elements of an Ad campaign.

FIG. 2 is a schematic illustration of the flow of input and output data of the method.

FIG. 3 is a schematic flow diagram showing how an Ad campaign begins and is executed using the disclosed invention.

### DETAILED DESCRIPTION

The invention in the Background is a method for automating the management of advertising campaigns which utilizes at least one database. The database is provided by a publisher or an ASP on his behalf. Generally, an ASP is the preferred location. The database(s) is interfaced with at least one client, wherein the client has at least one advertising campaign having at least one online advertisement; and where the database is interfaced with an Ad server. A few Ad servers tend to dominate the market place, providing large data warehouses. The Ad server can display at least one online advertisement onto at least one web page. As discussed of The Invention, the Ad server collects data as to who, what, when, where and how the advertisement is browsed by a viewer.

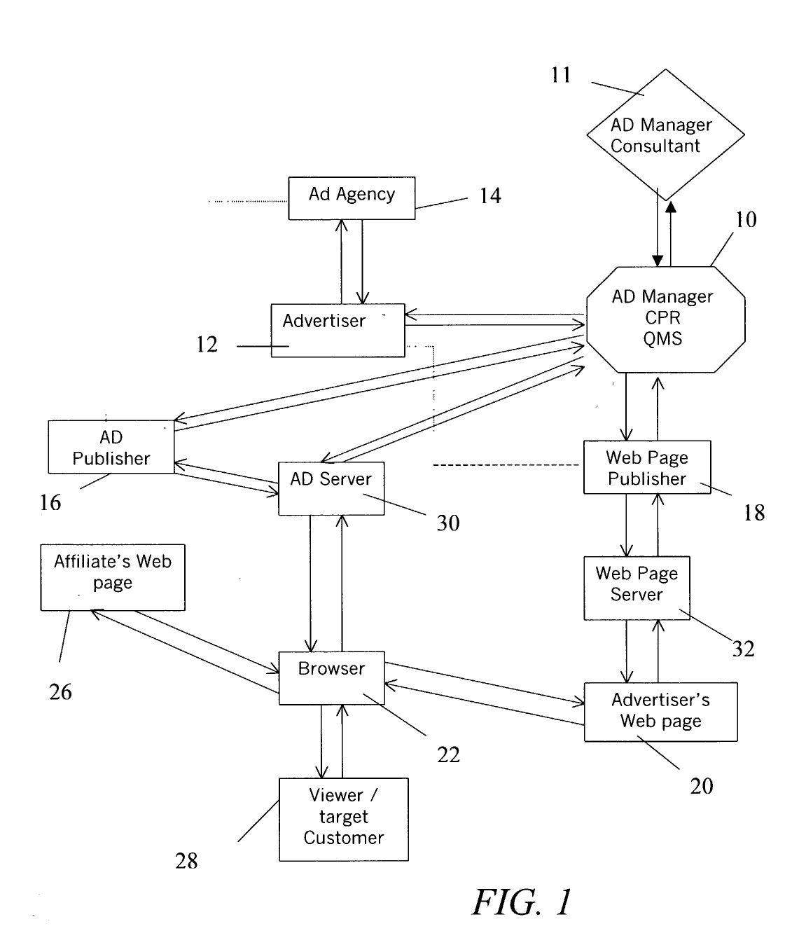

FIG. 1 is a flow diagram illustrating the overall schema of the invention and the operational elements of an Ad campaign. The Ad Manager 10 is comprised of a customized proactive reporting application (CRP) for managing communication between the publisher 18 and the client (advertiser) 12 through a web page based interface. The arrows indicate communication is capable of going in both directions. It is understood that communication outside the scope of the invention is not shown. The publisher 18 and the advertiser 12 obviously would need additional channels, and this is shown with a dashed line. The Ad Agency 14, is assumed to work for the advertiser as a creative resource, and not for Ad campaign oversight, and therefore is out of direct communication with the publisher. This arrangement is subject to individual preferences.

The publisher 18 creates web pages using a server 32. The web page server 32 has the capability of detecting and tracking when a page has been impressed or clicked through, and determining the source of the browser 22. The Ad Manager is capable of directly interfacing with the Ad server, and downloading collected data. The collected data is determined by the parsed SQL entered by the client/advertiser 12. Additionally, targeting criteria can be uploaded to the Ad server, also entered by the client 12. Some requests are controlled by the Ad publisher 16, and therefore indirect communication is also required.

In operation, the target customer/viewer 28 browses 22 the web until he finds the web page he is initially seeking, which is shown as an affiliates web page 26. The affiliate sends a cookie back to the browser 22, which then forwards it into the Ad server 30. The as server then generates an Ad that was created by the publisher 16 at the bequest of the Ad agency 14 working for the advertiser 12. The Ad is superimposed on the web page 12 of the affiliate's. The targeting criteria are set by the advertiser 12 through the Ad manager 10. On clicking the Ad, the viewer is transported to the advertiser's web page 20, produced on the web page server 32 by the publisher 18. The publisher has an inventory of web pages, and is running a number of ad campaigns. On occasion it may be desirable to contact an Ad consultant 11, which can be a virtual consultant such as an AI database or a person with specialized knowledge in the area.

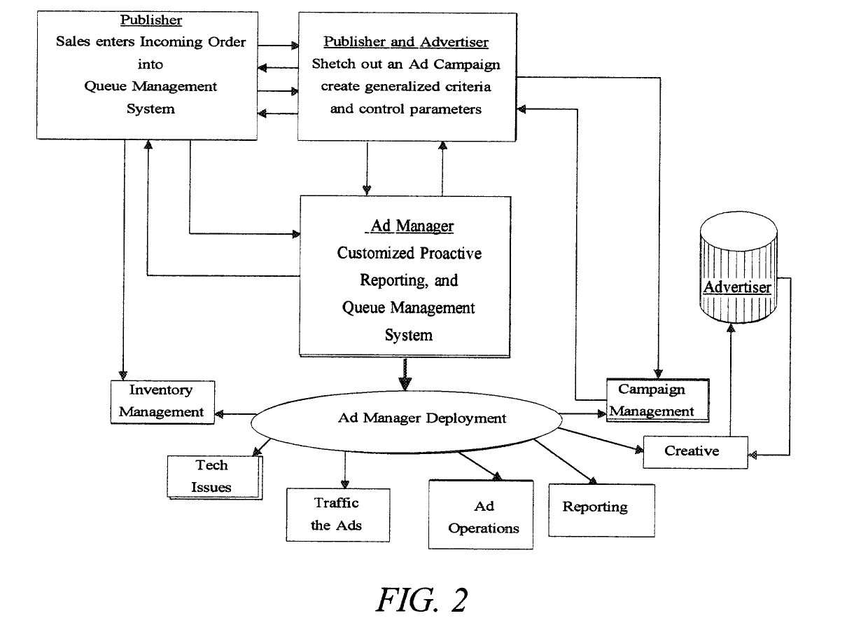

FIG. 2 is a schematic illustration of the flow of input and output data of the method. The publisher, 18 in FIG. 1, gets directions from the advertiser, 12 in FIG. 1, to develop an Ad campaign. The sales force enter the incoming order into the queue after developing some generalized criteria including the campaign name, advertiser ID, start date, end date, impression level, cost per thousand and what are the targeting criteria. These criteria are then entered into the AD Manager which automatically deploys the Ad. With the Ad deployed, the advertiser along with the publisher can then monitor its performance. Of particular interest to the advertiser is the customized proactive reporting (CPR), which integrates within the Ad server user interface or directly to the database, creating a customized client-side interface, that provides customized client-side field inputs and dynamically converts client inputs into standardized Ad serving outputs in Excel®, html, csv or xml data-types.

The CPR also generates forecasts and computes revenues by network/site level, campaign level, and trends by advertiser site area. The CPR also lists the top performing campaigns ranked by click through rate, on-time delivery, and bottom performing campaigns ranked by click through rate, over/under delivery. There are drill-down productivity reports by page or tile targeted, geographical region, time-of-day and day-of-week, frequency of viewing, browser/operating system. Additionally there is inventory forecasting by availability at network, site, area, and page name levels.

CPR is of interest to both the client and the publisher because it contains applications for inventory forecasting, which can identify pockets of unsold inventory. The forecasting application computes the cost of unsold inventory, and merges targeting criteria with available inventory to pre-packaged media selling opportunities.

Of particular utility to the publisher the method employs a queue management system (QMS), which is an open channel between the publisher and its client advertisers, that automates the management of the clients Ad campaign work flow. Typically, a customer relationship management application (CRM) is used to augment structured query language (SQL) queries. Additionally, an application programming interface (API) is used to query the Ad server. When a client makes a request the client's requests are logged and tagged with a unique case ID, a request type, a completion date, and a specific task(s) to be completed. There is an alert system, which monitors the response times to a client's request, and the alert system, which is weighted according to the level of urgency as determined by the client, can dynamically sort client requests. The dynamic sorting and reallocation of requests is prioritized via the client employees that stage queues, which are dependent on resource availability. The client and the publisher can track an Ad campaign by turnaround times, billing terms, units, and rates on an individual basis, or on an aggregate basis. The client and the publisher can also track aggregates, which provide an overview of billing, work-log, and performance summaries on a client-by-client basis, to easily identify resource utilization, productivity, and ROI. The aggregates are particularly useful to the publisher in identifying how well their various clients' Ad campaigns are performing.

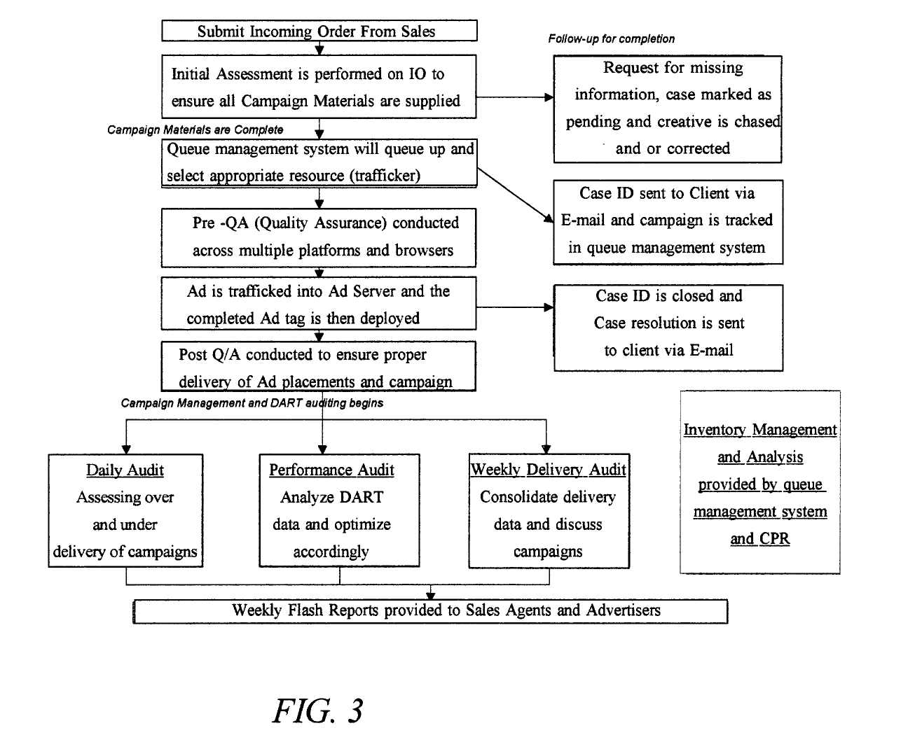

FIG. 3 is a schematic flow diagram showing how an Ad campaign begins and is executed using the disclosed invention. FIG. 3 is largely self-explanatory. The interface between the Ad server and the Ad manager is through DART®, which is a Double Click technology developed to help advertisers and Ad agencies to control and centralize the targeting, delivery and reporting of their online campaigns, across any site on the web. Information retrieved using DART is converted in a graphical format, and can be cross-referenced to a web page trafficker, which gathers similar data from visits to the advertiser's web page.

In summary the method utilizes an open platform, enabling e-business® with vendors and suppliers. The method can be supplemented with an Ad consultant, which is an artificial intelligence (AI) application having expert knowledge in Ad campaigns. The Ad consultant can also be a person(s), or a person(s), or a person(s) utilizing an AI application expert.

It is anticipated that the method of automated Ad campaign management employs an application that is holistic, robust and client friendly. The application can use customer relationship management tools, such as CRM® by Salesforce.com to facilitate API queries.

1. A method for automating the management of advertising campaigns which utilizes at least one database, wherein the database, which is provided by a publisher or an ASP on his behalf, the database is interfaced with at least one client, wherein the client has at least one advertising campaign having at least one online advertisement; and where the database is interfaced with an Ad server, wherein the Ad server can display at least one online advertisement onto at least one web page, and wherein said Ad server collects data as to who, what, when, where and how the advertisement is browsed by a viewer; wherein said method comprises:
Providing, by the publisher, an Ad Manager having an Internet compatible customized proactive reporting application for the client, where the client is an advertiser or his representative, wherein said client uses the Internet to query the database as to a status of the Ad campaign, as to a cost of the Ad campaign, as to initiating a new or terminating an existing Ad campaign, as to an inventory status report and as to a technical issue(s); and
On a continuing automated basis, ad manager is downloading the collected data from the ad server, analyzing the collected data, storing the analyzed collected data in an internet application compatible database format, where the collected data is tagged so as to have an associated unique identified as to client, ad campaign and advertisement, along with the who, what, when, where and how collected data.

2. A method for automating the management of advertising campaigns according to claim 1, wherein the Internet compatible customized proactive reporting application enables the client to specify the analysis criteria and to change criteria controlling targeted/tailored ads.

3. A method for automating the management of advertising campaigns according to claim 1, wherein analysis criteria can be sorted by Ad campaign management tools consisting of click through rate by site or by page or by tile, impression rate, frequency of viewing time-of-day, operating system, browser, geographical region, cost of ads per thousand, and over/under delivery.

4. A method for automating the management of advertising campaigns according to claim 1, further comprising providing a web page trafficker for tracking the who, what, where, when and how the viewer browsed the client's web page.

5. A method for automating the management of advertising campaigns according to claim 3, wherein, on a continuing automated basis, the Ad Manager downloads web page tracking data, which is cross referenced to the collected data from the Ad server, and therein enables analysis of which Ad campaign brought the viewer to the client's web.

6. A method for automating the management of advertising campaigns according to claim 5, wherein the Internet compatible customized proactive reporting application enables the client to specify the analysis criteria and to change criteria controlling targeted/tailored ads.

7. A method for automating the management of advertising campaigns according to claim 6, wherein analysis criteria can be sorted by Ad campaign management tools consisting of click through rate by site or by page or by tile, impression rate, frequency of viewing time-of-day, operating system, browser, geographical region, cost of ads per thousand, and over/under delivery, therein augmenting the client's ability to evaluate the effectiveness of any given Ad campaign

8. A method for automating the management of advertising campaigns according to claim 7, wherein a client can issue a request which is logged on the at least one database, and when the client issues the request, the request is tagged with a unique identified, a request type, a completion date and the specific tasks to be completed.

9. A method for automating the management of advertising campaigns according to claim 4, further comprising providing the Ad Manager with a queue management system which inventories all client requests and has an alert system that monitors response times and dynamically sorts client requests depending on the level of urgency.

10. A method for automating the management of advertising campaigns according to claim 9, wherein said Ad Manager aggregates billing, work-log, and performance summaries on client-by-client basis to easily identify resource utilization, productivity, and return on investment for the publisher.

11. A method for automating the management of advertising campaigns according to claim 10, wherein the Internet compatible customized proactive reporting application enables the client to specify the analysis criteria and to change criteria controlling targeted/tailored ads.

12. A method for automating the management of advertising campaigns according to claim 11, wherein analysis criteria can be sorted by Ad campaign management tools consisting of click through rate by site or by page or by tile, impression rate, frequency of viewing time-of-day, operating system, browser, geographical region, cost of ads per thousand, and over/under delivery.

13. A method for automating the management of advertising campaigns according to claim 9, further comprising providing a web page trafficker for tracking the who, what, where, when and how the viewer browsed the client's web page.

14. A method for automating the management of advertising campaigns according to claim 9, wherein, on a continuing automated basis, Ad Manager downloads web page tracking data, which is cross referenced to the collected data from the Ad server, and therein enables analysis of which Ad campaign brought the viewer to the client's web.

15. A method for automating the management of advertising campaigns according to claim 5, wherein the analysis criteria can be sorted by Ad campaign management tools consisting of click through rate by site or by page or by tile, impression rate, frequency of viewing time-of-day, operating system, browser, geographical region, cost of ads per thousand, and over/under delivery, therein augmenting the client's ability to evaluate the effectiveness of any given Ad campaign

16. A method for automating the management of advertising campaigns according to claim 9, wherein said Internet compatible customized proactive reporting application provides the client with a forecast(s), where the forecasts consist of forecast revenues, forecast inventory of ads, performance, selling opportunities and client specified requests and calculations.

17. A method for automating the management of advertising campaigns according to claim 1, wherein said Internet compatible customized proactive reporting application provides the client with a forecast(s), where the forecasts consist of forecast revenues, forecast inventory of ads, performance, selling opportunities and client specified requests and calculations.

18. A method for automating the management of advertising campaigns according to claim 9, further comprising providing an Ad consultant, where the Ad consultant is a resource to the Ad Manager and the client, wherein said resource can be virtual or human or a mix thereof.

19. A method for automating the management of advertising campaigns according to claim 1, further comprising providing an Ad consultant, where the Ad consultant is a resource to the Ad Manager and the client, wherein said resource can be virtual or
